(19) United States
(12) Patent Application Publication
(10) Pub. No.: US 2025/0061266 A1
(43) Pub. Date: Feb. 20, 2025

(54) METHOD FOR GENERATING PAGE, STORAGE MEDIUM AND ELECTRONIC DEVICE

(71) Applicant: Lemon Inc., Grand Cayman (CN)

(72) Inventors: Jianqi JIN, Beijing (CN); Xiangbin ZHANG, Beijing (CN)

(21) Appl. No.: 18/805,417

(22) Filed: Aug. 14, 2024

(30) Foreign Application Priority Data
Aug. 15, 2023 (CN) 202311025138.2

(51) Int. Cl. G06F 40/106

(52) U.S. Cl. CPC G06F 40/106

(57) ABSTRACT

A method for generating a page, storage medium and electronic device. The method includes: acquiring target information inputted by a user, and acquiring preliminary layout information of a target page for the target information through a generative language model, the preliminary layout information including component information of a plurality of page components forming the target page; respectively acquiring internal structure information of each of the plurality of page components through the generative language model; and obtaining target layout information corresponding to the target page by combining the preliminary layout information and internal structure information of each of the plurality of page components; and according to the target layout information, performing page rendering through a page rendering engine, so as to obtain the target page.

### CROSS-REFERENCE TO RELATED APPLICATION(S)

The present application claims priority of the Chinese Patent Application No. 202311025138.2 filed on Aug. 15, 2023, the content of which is incorporated as a part of the present application.

### TECHNICAL FIELD

Embodiments of the present disclosure relate to the technical field of generative artificial intelligence, and specifically relate to a method and apparatus for generating a page, an electronic device and a storage medium.

### BACKGROUND

Existing application software usually displays information to users or provides an operation interface for users through application pages. However, the page design of existing application software often tends to be complicated and functional, which makes it difficult for users to find the specific page they want to view or operate conveniently, resulting in the increasing of use cost of the users. It often requires long-term exploration or professional training before they can skillfully use the software.

In order to improve the work efficiency of users, a novel page generation method is needed.

### SUMMARY

Embodiments of the present disclosure provide a method for generating a page, an electronic device and a storage medium.

According to the first aspect, at least one embodiment of the present disclosure provides a method for generating a page, which includes:
acquiring target information inputted by a user, and acquiring preliminary layout information of a target page for the target information through a generative language model, the preliminary layout information comprising component information of a plurality of page components forming the target page; respectively acquiring internal structure information of each of the plurality of page components through the generative language model; and
obtaining target layout information corresponding to the target page by combining the preliminary layout information and internal structure information of each of the plurality of page components; and according to the target layout information, performing page rendering through a page rendering engine, so as to obtain the target page.

According to the second aspect, at least one embodiment of the present disclosure provides a
an acquisition unit which is configured to acquire target information inputted by a user, and acquire preliminary layout information of a target page for the target information through a generative language model, the preliminary layout information comprising component information of a plurality of page components forming the target page; and respectively acquire internal structure information of each of the plurality of page components through the generative language model; and
a generation unit which is configured to obtain target layout information corresponding to the target page by combining the preliminary layout information and internal structure information of each of the plurality of page components; and according to the target layout information, perform page rendering through a page rendering engine, so as to obtain the target page.

According to the third aspect, at least one embodiment of the present disclosure provides a computer-readable storage medium, wherein a computer program is stored on the computer-readable storage medium; and when the computer program is executed in a computer, the computer executes the method according to the first aspect.

According to the fourth aspect, at least one embodiment of the present disclosure provides an electronic device, including a memory and a processor, wherein the memory stores executable codes; and the processor can execute the executable codes to implement the method according to the first aspect.

### BRIEF DESCRIPTION OF DRAWINGS

FIG. 1 is a schematic diagram of a method for generating a page according to an embodiment of the present disclosure;

FIG. 2 is a schematic diagram of a page structure according to an embodiment of the present disclosure;

FIG. 3 is a flow schematic diagram of a method for generating a page according to an embodiment of the present disclosure;

FIG. 4 is a schematic diagram of prompt information for selecting a component according to an embodiment of the present disclosure;

FIG. 5 is a schematic diagram of prompt information for acquiring preliminary layout information according to an embodiment of the present disclosure;

FIG. 6 is a schematic diagram of prompt information for acquiring internal structure information according to an embodiment of the present disclosure;

FIG. 7 is a schematic block diagram of an apparatus for generating a page according to an embodiment of the present disclosure;

FIG. 8 is a structural schematic diagram of an electronic device suitable for implementing embodiments of the present disclosure; and

FIG. 9 is a structural schematic diagram of a storage medium suitable for implementing embodiments of the present disclosure.

### DETAILED DESCRIPTION

In the following, the technical solution provided in this specification will be further described in detail with the attached drawings and examples. It can be understood that the specific embodiments described here are only used to explain the related invention, but not to limit the invention. In addition, for the convenience of description, only the parts related to the invention are shown in the attached drawings. It should be noted that the embodiments of the present disclosure and the features in the embodiments can be combined with each other without conflict.

In the description of the implementation of the present disclosure, the term “including” and similar terms should be understood as open inclusion, that is, “including but not limited to”. The term “based on” should be understood as “at least partially based on”. The terms “one implementation” or “the implementation” should be understood as “at least one implementation”. The term “some implementations” should be understood as “at least some implementations”. Other explicit and implicit definitions may be included below.

As described above, existing application software usually displays information to users or provides an operation interface for users through application pages. However, the page design of existing application software often tends to be complicated and functional, which makes it difficult for users to find the specific page they want to view or operate conveniently, resulting in the increasing of use cost of the users. It often requires long-term exploration or professional training before they can skillfully use the software. Moreover, there are a large number of functional components that can be called on the application page, and the users often hope to quickly find the functional components with high availability.

According to an existing conventional page design solution, pages in the application software usually have fixed functions and are located in a specific link relationship with other pages contained in the software, and the functional components contained in the pages are usually fixed. The users can carry out expected operation only by being familiar with the link relationship between different pages in the software and the functional components in each page. Therefore, according to a conventional page design solution, it is difficult to solve the problem that the users can quickly access a page (such as the functional component with high availability) to be viewed or operated.

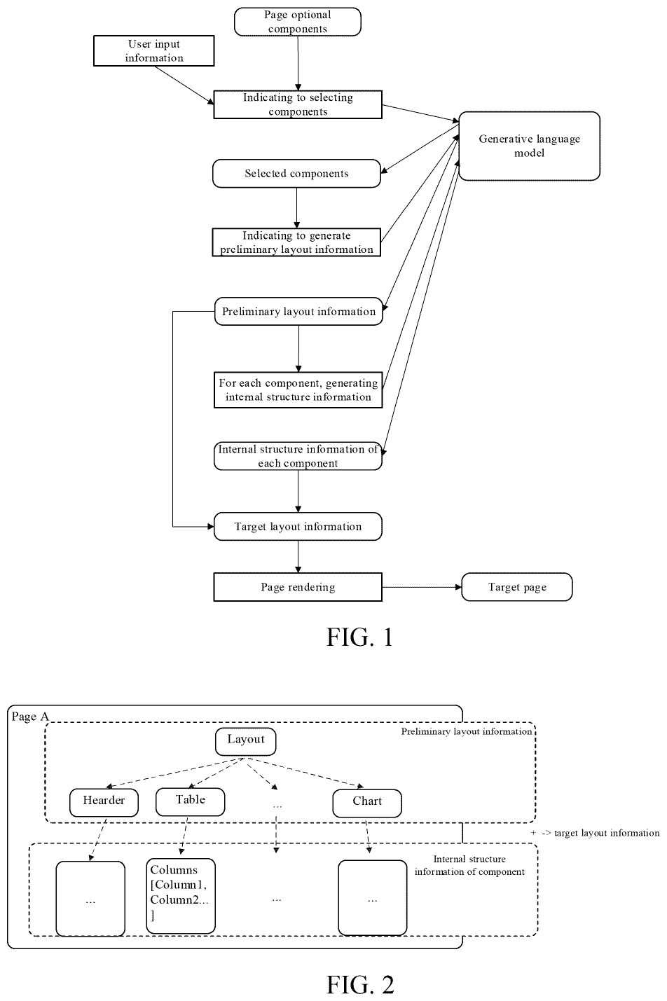

In order to solve the above technical problems, an embodiment of the present disclosure provides a method for generating a page. FIG. 1 is a schematic diagram of a method for generating a page according to an embodiment of the present disclosure. As shown in the FIG. 1, in some embodiments, target information such as a natural language form inputted by the user, description information of predetermined page optional components (short for optional components), and indication information for selecting a component from the page optional components to form a target page for the target information (or a page component for short) can be combined and transmitted to a generative language model, so as to obtain description information of the page component outputted by the generative language model. Then, the description information of the page component, and the indication information for generating the preliminary layout information of the page are transmitted to the generative language model to obtain the preliminary layout information outputted by the generative language model, and the preliminary layout information may include component information of the page component based on a specific data format. The indication information for generating internal structure information for each component can be transmitted to the generative language model, so as to acquire the internal structure information of each of the plurality of page components. For example, FIG. 2 is a schematic diagram of a page structure according to an embodiment of the present disclosure. In the example shown in FIG. 2, for example, the preliminary layout information of a page A may include the component information of the page components forming the page A, for example, a layout root node component (layout), a header component (Header), a table component (Table), and a chart component (Chart). The internal structure information of each of the plurality of page components may include the information of page elements included in each of the plurality of page components, for example, the internal structure information of the table component may include columns of column elements included in the component. And then, target layout information corresponding to the target page can be obtained by combining the preliminary layout information and the internal structure information of each of the plurality of page components, and page rendering is carried out through a page rendering engine according to the target layout information, so as to obtain the target page. The method has the advantages that: firstly, the target page corresponding to semantics of natural language information can be generated according to the natural language information inputted by the user, so that the user can access the page which the user wants to access in a highly concise mode, and the user intention represented in the natural language information is achieved through the page by the page component with high availability, and thus the working efficiency of the user is greatly improved. Secondly, in the process of generating the target page, sub-steps are carried out to respectively acquire the preliminary layout information and the internal structure information of each of the plurality of page components from the generative language model, and then combine the preliminary layout information and the internal structure information of each of the plurality of page components to obtain the target layout information. The problem that in the process of acquiring the layout information, the single output or output data volume of the generative language model is too large, and exceeds the input or output threshold of single access, resulting in difficult acquisition of the layout information is solved. Thirdly, in the process of generating the target page, the generative language model is indicated to select the composition component (page component) of the target page from the predetermined optional components such as enterprise internal or external accessible components, the range of the page composition component is reasonably limited, thus the possibility that the selected page component is an unavailable component or an inapplicable component is reduced, and the availability of the target page formed by the page component is improved.

The detailed process of this method is further described below.

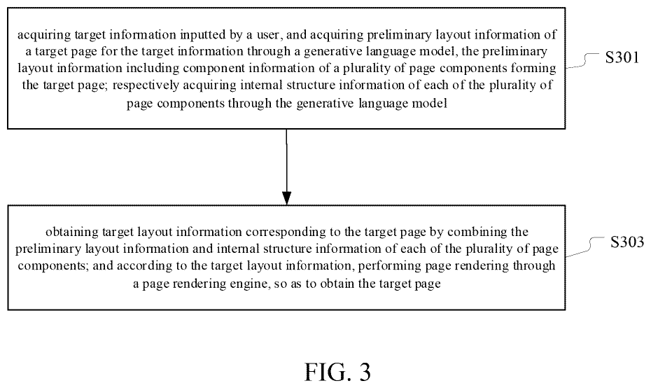

FIG. 3 is a flow schematic diagram of a method for generating a page according to an embodiment of the present disclosure. As shown in FIG. 3, the method includes at least the following steps:
S301, acquiring target information inputted by a user, and acquiring preliminary layout information of a target page for the target information through a generative language model, the preliminary layout information including component information of a plurality of page components forming the target page; respectively acquiring internal structure information of each of the plurality of page components through the generative language model; and
S303, obtaining target layout information corresponding to the target page by combining the preliminary layout information and internal structure information of each of the plurality of page components; and according to the target layout information, performing page rendering through a page rendering engine, so as to obtain the target page.

Firstly, in S301, the target information inputted by the user is acquired, and the preliminary layout information of the target page for the target information is acquired through the generative language model, the preliminary layout information including the component information of the plurality of page components forming the target page; and the internal structure information of each of the plurality of page components is acquired through the generative language model.

The generative language model can be a neural network model which is based on natural language processing and can be used for text generation, and it can generate natural and smooth text output meeting grammar rules according to inputted text content in the natural language form. In different embodiments, different specific types of generative language models can be adopted, which is not limited in the specification. Because the generative language model can conduct text input on the natural language information, in one embodiment, the target information inputted by the user can be the natural language information.

In different embodiments, the target information inputted by the user can be different specific information, and the intention represented by the user inputting the target information can also be different specific intentions, which is not limited in the specification. For example, in one example, when a user wants to submit a leave request, the user can input a natural language “application for leave”. In another example, when a user wants to display the work progress, the user can input a natural language “generate weekly report of the latest week”. The target page can be a page generated according to the intention represented by the user using the target information. In different embodiments, according to different intentions represented by the user using the target information, the generated target pages may also be different.

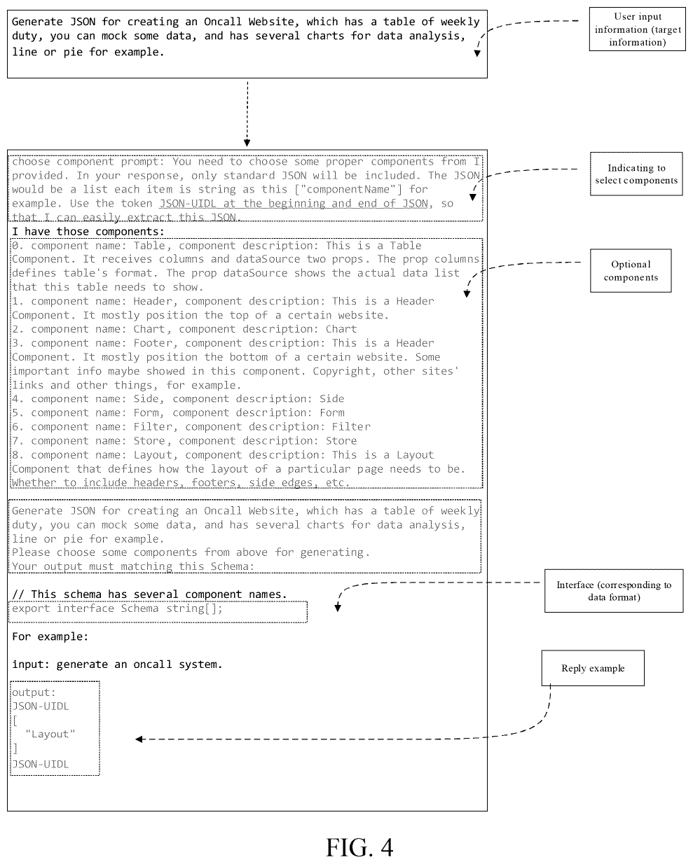

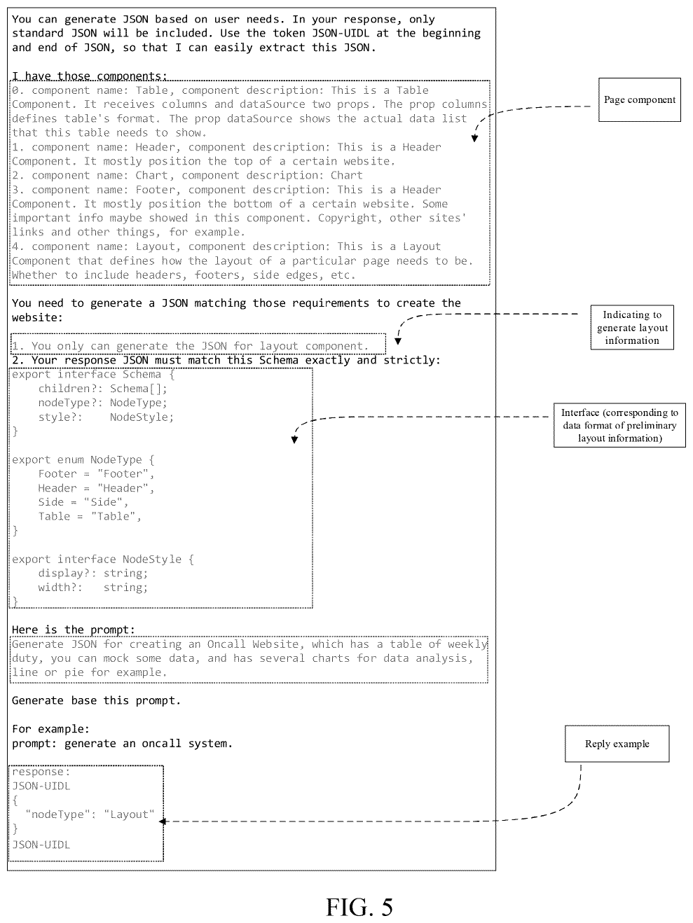

In different embodiments, the specific modes for acquiring the preliminary layout information of the target page for the target information through the generative language model may be different. In one embodiment, the target information, description information of a plurality of optional components that are predetermined, and first indication information for indicating to determine the page components from the optional components can be inputted into the generative language model to obtain the plurality of page components determined from the plurality of optional components that are outputted by the generative language model. And then, the target information, the description information of each of the plurality of page components, and second indication information for indicating to generate the preliminary layout information are inputted into the generative language model to obtain the preliminary layout information outputted by the generative language model. FIG. 4 is a schematic diagram of prompt information for selecting a component according to an embodiment of the present disclosure. In an example shown in the FIG. 4, for example, the description information of the optional components, and the indication information (first indication information) for determining the page components from the optional components can be transmitted to the generative language model. FIG. 5 is a schematic diagram of prompt information for acquiring preliminary layout information according to an embodiment of the present disclosure. In an example shown in the FIG. 5, for example, the description information of the determined page components, and the indication information (second indication information) for generating the preliminary layout information can be transmitted to the generative language model.

In different specific embodiments, the optional components include one or more of a user interface (UI) component for displaying a user interface, a data component for providing data, a logic component for performing logic processing, and the like. In different specific embodiments, the optional components can be, for example, internal components of an enterprise, and can also be accessible external components. In a specific embodiment, the description information of the plurality of optional components that are predetermined can include names of the optional components and/or function description of the optional components. According to the above modes, the composition components of the page are determined from the pre-integrated optional components (such as the optional components which can be accessed from the interior or the exterior of the enterprise), the range of the page composition components can be reasonably limited, and thus the possibility that the selected page components are unavailable components or inapplicable components is reduced.

In one embodiment, the first indication information can also include: indication information for a data format Schema (such as a first data format) associated with the description information of each of the plurality of page components outputted by the generative language model. Therefore, the outputted description information of each of the plurality of page components based on the first data format can be obtained from the generative language model. In this way, the outputted data format (Schema) is indicated to the generative language model, so that the output result of the generative language model can be restrained conveniently to meet the expected data format conveniently, facilitating subsequent data processing. In a specific embodiment, the first data format can also be represented through information (such as first interface information) of an interface based on a predetermined programming language. Furthermore, the first indication information can also include the first interface information, as shown in the FIG. 4. In different specific embodiments, the predetermined programming language may be different specific programming languages. The data format is represented through the information of the interface of the predetermined programming language; and compared with a conventional Schema representation mode (such as Jason format representation), it requires shorter the required text, and it can be understood and processed by the generative language model. Therefore, the number of the data inputted to the generative model can be further reduced, then the possibility that the single input of the generative language model exceeds the input threshold is further reduced, and the use cost of the generative language model can be reduced.

In actual production process, information beyond the expected result (such as description information of the page component determined from the optional component) is often mixed in the output result of the generated language model. Therefore, in order to conveniently extract the expected result from the output result of the generated language model, in one specific embodiment, the first indication information can also include: an encapsulating mode of the description information of each of the plurality of page components outputted by the generated language model, and/or, example information of the encapsulating mode. In different specific embodiments, the encapsulating modes may be different specific encapsulating modes. For example, the specific encapsulating mode in the example shown in the FIG. 4 can be to encapsulate the returned description information of each of the plurality of page components with SON-UIDL[“ . . . ”]JSON-UIDL.

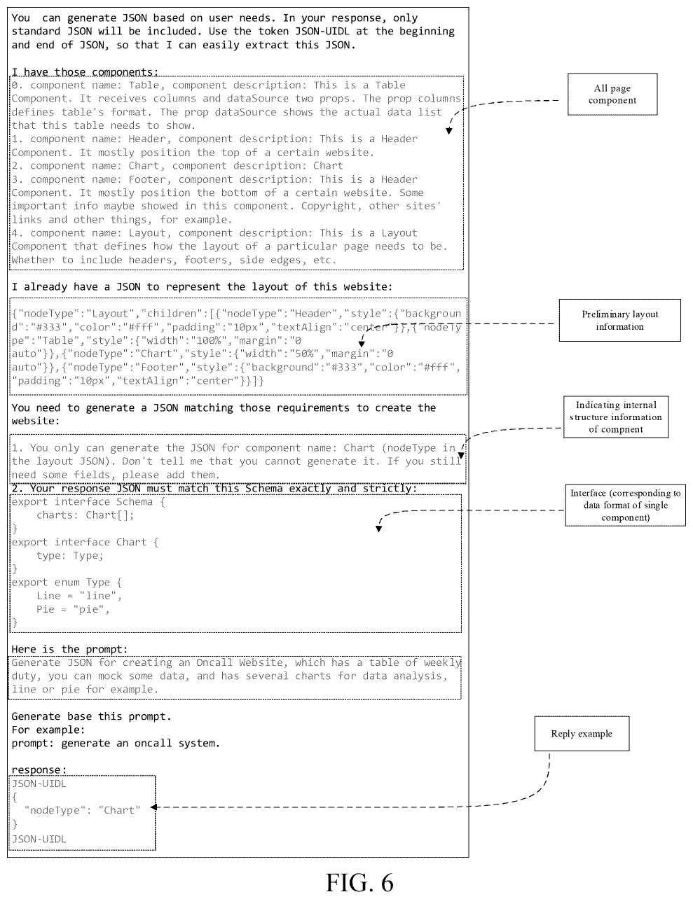

In different embodiments, the specific modes for acquiring the internal structure information of each of the plurality of page components may be different. In one embodiment, the internal structure information of each of the plurality of page components is acquired specifically in the following mode: for each of the plurality of page components, inputting the target information, the preliminary layout information, and third indication information for indicating to generate the internal structure information of the page component into the generative language model, as shown in FIG. 6. Then the outputted internal structure information of the page component is obtained. Through the above mode, the internal structure information of each of the plurality of page components is obtained from the generative language model. And a situation that the single output or output data volume of the generative language model is too large and exceeds the input or output threshold of single access can be avoided.

Similar to the first indication information, the second indication information and the third indication information can also include one or more of data format information represented through the interface information, the encapsulating mode of the expected information, and the encapsulating example, for example, as shown in the FIG. 5 and FIG. 6, the effect of the second indication information and the third indication information is similar to that of the similar information included in the first indication information, which is not listed here. And the data formats associated with different page components may be different. Therefore, in one embodiment, for each of the plurality of page components, a second data format associated with the page component can be acquired, and the second data format is represented through second interface information based on the predetermined programming language. Furthermore, the third indication information may include the second interface information.

Then, in S303, the preliminary layout information, and the internal structure information of each of the plurality of page components are combined to obtain the target layout information corresponding to the target page; and according to the target layout information, page rendering is carried out through the page rendering engine to obtain the target page.

In this step, the preliminary layout information acquired in S301, and the internal structure information of each of the plurality of page components can be combined to obtain the complete layout information corresponding to the target page, namely target layout information. In different embodiments, the target layout information obtained through combination may be different for different target information inputted by the user. In one embodiment, in order to facilitate subsequent page rendering, the target layout information can be the layout information based on the predetermined user interface definition language (IDL). In different embodiments, the predetermined user interface definition languages may be different, which is not limited in the specification. In order to conveniently combine the target layout information, in one embodiment, in the indication information (such as second indication information) which is transmitted to the generative language model for generating the preliminary layout information in S301, the indicated data format of the preliminary layout information can be a data format based on the predetermined user interface definition language. Similarly, in the indication information (such as third indication information) which is transmitted to the generative language model for generating internal structure information of each of the plurality of page components, the indicated data format of the internal structure information may also be a data format based on the predetermined user interface definition language.

After the target layout information is obtained, page rendering can be carried out through the page rendering engine according to the target layout information, so as to obtain the target page. In different embodiments, specific page rendering engines for page rendering may be different, which is not limited in the specification.

In one embodiment, after S303, the target page can also be displayed to the user. In different embodiments, according to different intentions represented by the user input information (target information) acquired in S301, the target page can be, for example, used for the user to perform expected operation through the target page, or display expected data to the user. In another example, when a user wants to submit a leave request, the user can input the natural language “application for leave”. The target page can display a component for leave process, and a component for submitting the leave request, so that the user can conveniently view the leave application process through the target page and submit the leave request. In another example, when a user wants to display the work progress, the user can input a natural language “generate weekly report of the latest week”. And then data or logic components associated with the weekly report can be determined, the weekly report data is queried through the data or logic components, and then a query result is displayed, for example, through the table component. In this way, the target page corresponding to the semantics of the natural language information can be generated according to the natural language information inputted by the user, so that the user can access the page which the user wants to access in the highly concise mode; and moreover, the user intention represented in the natural language information is completed through the page by the page component with high availability, and thus the working efficiency of the user is greatly improved.

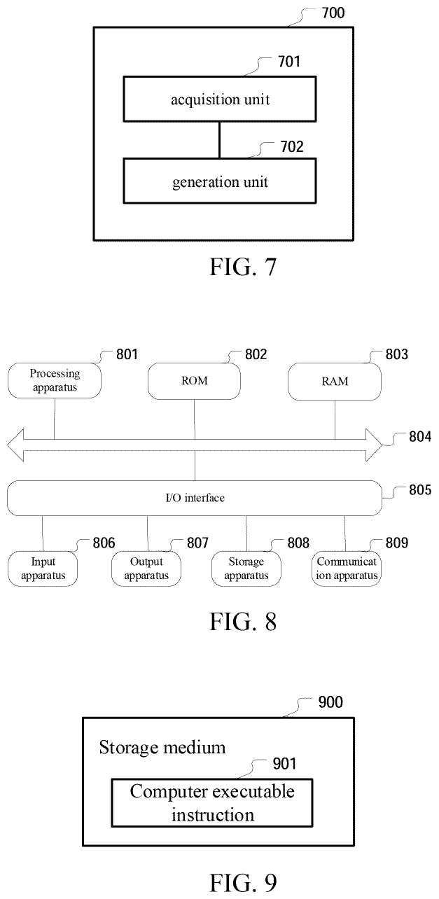

FIG. 7 is a schematic block diagram of an apparatus for generating a page according to an embodiment of the present disclosure. The apparatus is configured to implement the method shown in the FIG. 3, as shown in the FIG. 7, the apparatus 700 includes:
an acquisition unit 701 which is configured to acquire target information inputted by a user, and acquire preliminary layout information of a target page for the target information through a generative language model, the preliminary layout information including component information of a plurality of page components forming the target page; and respectively acquire internal structure information of each of the plurality of page components through the generative language model; and
a generation unit 702 which is configured to obtain target layout information corresponding to the target page by combining the preliminary layout information and internal structure information of each of the plurality of page components; and according to the target layout information, perform page rendering through a page rendering engine, so as to obtain the target page.

An embodiment of the present disclosure also provides an electronic device, including a memory and a processor. The memory stores executable codes; and the processor can execute the executable codes to implement the method shown in the FIG. 3.

FIG. 8 is a structural schematic diagram of an electronic device 800 suitable for implementing embodiments of the present disclosure. The electronic device 800 shown in the FIG. 8 is only an example and should not impose any restrictions on the functions and usage scope of the embodiments of the present disclosure.

As shown in the FIG. 8, the electronic device 800 may include a processing apparatus (such as a central processing unit, and a graphics processor) 801. The above-mentioned processing apparatus 801 can be a general-purpose processor, a digital signal processor (DSP), a microprocessor or a microcontroller, and can further include an application specific integrated circuit (ASIC), a field programmable gate array (FPGA) or other programmable logic apparatuses, discrete gate or transistor logic apparatuses, discrete hardware components, which can perform various appropriate actions and processes according to the program stored in a read-only memory (ROM) 802 or the program loaded from a storage apparatus 808 program into a random access memory (RAM) 803. In the RAM 803, various programs and data required for the operation of the electronic apparatus 800 are also stored. The processing apparatuses 801, ROM 802 and RAM 803 are connected to each other via a bus 804. An input/output (I/O) interface 805 is also connected to the bus 804.

Generally, the following apparatuses can be connected to an I/O interface 805: an input apparatus 806 including, for example, a touch screen, a touch pad, a keyboard, and a mouse; an output apparatus 807 including, for example, a liquid crystal display (LCD), a speaker, and a vibrator; a storage apparatus 808 including, for example, a tape, and a hard disk; and a communication apparatus 809. The communication apparatus 809 may allow an electronic device 800 to be in wireless or wired communication with other devices to exchange data. Although the electronic device 800 with various apparatuses is shown in the FIG. 8, it is to be understood that it is not required to implement or have all the shown apparatuses. More or less apparatuses may be implemented or provided instead. Each block shown in the FIG. 8 may represent one apparatus or may represent a plurality of apparatuses as needed.

In particular, according to embodiments of the present disclosure, the process described above with reference to the flowchart may be implemented as a computer software program. For example, an embodiment of the present disclosure includes a computer program product, including a computer program carried on a computer-readable medium, and the computer program includes a program code for executing the method shown in the flowchart. In such embodiments, the computer program can be downloaded and installed from a network through the communication apparatus 809, or installed from the storage apparatus 808, or installed from the ROM 802. When the computer program is executed by the processing apparatus 801, the above functions defined in the method for generating pages according to the embodiments of the present application are executed.

An embodiment of the present disclosure further provides a computer-readable storage medium, and a computer program is stored on the computer-readable storage medium; and when the computer program is executed in a computer, the computer executes the method for generating the page according to the embodiment of the present disclosure shown in the FIG. 3. FIG. 9 is a structural schematic diagram of a storage medium for implementing embodiments of the present disclosure. For example, as shown in the FIG. 9, the storage medium 900 can be a non-temporary computer-readable storage medium and is configured to store a non-temporary computer executable instruction 901. When the non-temporary computer executable instruction 901 is executed by the processor, the method for generating the page according to the embodiment of the present disclosure can be realized, for example, when the non-temporary computer executable instruction 901 is executed by the processor, one or more steps in the method for generating the page according to the embodiment of the present disclosure can be executed. For example, the storage medium 900 can be applied to the above electronic devices, for example, the storage medium 900 can include the memory in the electronic device. Description about the storage medium 900 can refer to description about the memory in the embodiment of the electronic device, and the repeated part is not listed here. The specific function and the technical effect of the storage medium 900 can refer to the description about the method for generating the page according to the embodiment of the present disclosure, and the repeated part is not listed here.

It should be noted that the computer-readable medium of the embodiment of the present disclosure can be a computer-readable signal medium or a computer-readable storage medium or any combination of the two. The computer-readable storage medium can be, for example, but not limited to, an electrical, magnetic, optical, electromagnetic, infrared, or semiconductor system, device or device, or a combination of any of the above. More specific examples of computer-readable storage media may include, but are not limited to, an electrical connection with one or more wires, a memory card of a smart phone, a storage part of a tablet computer, a portable computer disk, a hard disk of a personal computer, a random access memory (RAM), a read-only memory (ROM), an erasable programmable read-only memory (EPROM or flash memory), an optical fiber, a portable compact disk read-only memory (CD-ROM), an optical storage device, and a magnetic device. In an embodiment of the present disclosure, a computer-readable storage medium can be any tangible medium containing or storing a program, which can be used by or in combination with an instruction execution system, apparatus or device. In the embodiment of the present disclosure, the computer-readable signal medium may include a data signal propagated in baseband or as a part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program code contained in the computer-readable medium can be transmitted by any suitable medium, including but not limited to: wires, optical cables, RF (Radio Frequency), etc., or any suitable combination of the above.

The computer-readable medium may be included in the electronic device; Or it can exist alone without being assembled into the electronic equipment. The computer-readable medium carries one or more programs, and when the one or more programs are executed by the server, the electronic device can realize the page generation method provided by the embodiment of the application.

Computer program codes for performing the operations of embodiments of the present disclosure may be written in one or more programming languages or their combinations, including object-oriented programming languages such as Java, Smalltalk, C++, and conventional procedural programming languages such as “C” or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions. The units involved in the embodiment described in the present disclosure can be realized by software or hardware. Among them, the name of the unit does not constitute the limitation of the unit itself in some cases. The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

Each embodiment in this specification is described in a progressive way, and only the same and similar parts between the embodiments can be referred to each other, and each embodiment focuses on the differences from other embodiments. Especially, for the storage medium and the computing device embodiment, because it is basically similar to the method embodiment, the description is relatively simple, and the relevant points can only be found in part of the description of the method embodiment.

The above description is only the preferred embodiment of the present disclosure and the explanation of the applied technical principles. It should be understood by those skilled in the art that the disclosure scope involved in this disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in this disclosure. Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

The above specific embodiment further explains the purpose, technical scheme and beneficial effects of the embodiment of the present invention in detail. Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims. It should be understood that the above is only the specific implementation of the embodiment of the invention, and it is not used to limit the protection scope of the invention. Any modification, equivalent substitution, improvement, etc. made on the basis of the technical scheme of the invention should be included in the protection scope of the invention.

1. A method for generating a page, comprising:
acquiring target information inputted by a user, and acquiring preliminary layout information of a target page for the target information through a generative language model, the preliminary layout information comprising component information of a plurality of page components forming the target page; respectively acquiring internal structure information of each of the plurality of page components through the generative language model; and
obtaining target layout information corresponding to the target page by combining the preliminary layout information and internal structure information of each of the plurality of page components; and according to the target layout information, performing page rendering through a page rendering engine, so as to obtain the target page.

2. The method according to claim 1, wherein the acquiring preliminary layout information of a target page for the target information through a generative language model comprises:
inputting the target information, description information of a plurality of optional components that are predetermined, and first indication information for indicating to determine the plurality of page components from the plurality of optional components into the generative language model, and obtaining the plurality of page components determined from the plurality of optional components that are outputted by the generative language model; and
inputting the target information, description information of the plurality of page components, and second indication information for indicating to generate the preliminary layout information into the generative language model to obtain the preliminary layout information outputted by the generative language model.

3. The method according to claim 2, wherein the respectively acquiring internal structure information of each of the plurality of page components through the generative language model comprises:
for each of the plurality of page components, inputting the target information, the preliminary layout information, and third indication information for indicating to generate internal structure information of a page component into the generative language model to obtain the internal structural information of the page component outputted by the generative language model.

4. The method according to claim 2, wherein the first indication information further comprises:
indication information of a data format associated with the description information of each of the plurality of page components outputted by the generative language model; and
the obtaining the plurality of page components determined from the plurality of optional components that are outputted by the generative language model comprises:
obtaining the description information of each of the plurality of page components based on the first data format that is outputted by the generative language model.

5. The method according to claim 4, further comprising: representing the first data format through first interface information based on a predetermined programming language; and
the first indication information comprises the first interface information.

6. The method according to claim 2, wherein the first indication information further comprises:
an encapsulating mode of the description information of each of the plurality of page components outputted by the generated language model, and/or, example information of the encapsulating mode.

7. The method according to claim 3, further comprising:
acquiring a second data format associated with the plurality of page components, and representing the second data format through second interface information based on a predetermined programming language; and
the third indication information comprises the second interface information.

8. The method according to claim 2, wherein the description information of the plurality of optional components that are predetermined comprises names of the plurality of optional components and/or function description of the plurality of optional components.

9. The method according to claim 1, further comprising: displaying the target page to the user.

10. The method according to claim 1, wherein the target information is natural language information.

11. A computer-readable storage medium, wherein a computer program is stored on the computer-readable storage medium; and when the computer program is executed in a computer, the computer executes the method according to claim 1.

12. An electronic device, comprising a memory and a processor, wherein the memory stores executable codes; and upon executing the executable codes, the processor is configured for:
acquiring target information inputted by a user, and acquiring preliminary layout information of a target page for the target information through a generative language model, the preliminary layout information comprising component information of a plurality of page components forming the target page; respectively acquiring internal structure information of each of the plurality of page components through the generative language model; and
obtaining target layout information corresponding to the target page by combining the preliminary layout information and internal structure information of each of the plurality of page components; and according to the target layout information, performing page rendering through a page rendering engine, so as to obtain the target page.

13. The electronic device according to claim 12, wherein the acquiring preliminary layout information of a target page for the target information through a generative language model comprises:
inputting the target information, description information of a plurality of optional components that are predetermined, and first indication information for indicating to determine the plurality of page components from the plurality of optional components into the generative language model, and obtaining the plurality of page components determined from the plurality of optional components that are outputted by the generative language model; and
inputting the target information, description information of the plurality of page components, and second indication information for indicating to generate the preliminary layout information into the generative language model to obtain the preliminary layout information outputted by the generative language model.

14. The electronic device according to claim 13, wherein the respectively acquiring internal structure information of each of the plurality of page components through the generative language model comprises:
for each of the plurality of page components, inputting the target information, the preliminary layout information, and third indication information for indicating to generate internal structure information of a page component into the generative language model to obtain the internal structural information of the page component outputted by the generative language model.

15. The electronic device according to claim 13, wherein the first indication information further comprises:
indication information of a data format associated with the description information of each of the plurality of page components outputted by the generative language model; and
the obtaining the plurality of page components determined from the plurality of optional components that are outputted by the generative language model comprises:
obtaining the description information of each of the plurality of page components based on the first data format that is outputted by the generative language model.

16. The electronic device according to claim 15, the processor is further configured for: representing the first data format through first interface information based on a predetermined programming language; and
the first indication information comprises the first interface information.

17. The electronic device according to claim 13, wherein the first indication information further comprises:
an encapsulating mode of the description information of each of the plurality of page components outputted by the generated language model, and/or, example information of the encapsulating mode.

18. The electronic device according to claim 14, the processor is further configured for:
acquiring a second data format associated with the plurality of page components, and representing the second data format through second interface information based on a predetermined programming language; and
the third indication information comprises the second interface information.

19. The electronic device according to claim 13, wherein the description information of the plurality of optional components that are predetermined comprises names of the plurality of optional components and/or function description of the plurality of optional components.

20. The electronic device according to claim 12, the processor is further configured for: displaying the target page to the user.
